(19) United States
(12) Patent Application Publication
(10) Pub. No.: US 2003/0159906 A1
(43) Pub. Date: Aug. 28, 2003

(54) Width adjustment for stackers and unstackers used with bakery product baskets and trays

(76) Inventors: William Aubrey Rinks, Wylie, TX (US); John Mitchell Lucido, Garland, TX (US)

Correspondence Address: Michael A. O'Neil, Michael A. O'Neil, P.C., 5949 Sherry Lane, Suite 820, Dallas, TX, 75225, US

(21) Appl. No.: 10/119,656

(22) Filed: Apr. 10, 2002

Related U.S. Application Data
(60) Provisional application No. 60/358,942, filed on Feb. 22, 2002.

(51) Int. Cl. B65G 41/00

(52) U.S. Cl. 198/586; 198/594

(57) ABSTRACT

An apparatus for facilitating the stacking and unstacking of bakery product baskets and trays characterized by varying widths includes a basket and tray transporting conveyor comprising spaced apart belts and guide members for positioning the baskets and trays relative to the conveyor. The belts comprising the conveyor and the guide members are mounted on subframes which are transversely positionable relative to the path of travel of baskets and trays under the action of the conveyor thereby facilitating the stacking and unstacking of bakery product baskets and trays characterized by varying widths.

### TECHNICAL FIELD

This invention relates generally to stackers and unstackers of the type used to stack and unstack bakery product baskets and trays, and more particularly to a width adjustment apparatus which facilitates the stacking and unstacking of bakery product baskets and trays having various widths.

### BACKGROUND AND SUMMARY OF THE INVENTION

Following their manufacture, mass produced bakery products are wrapped in plastic for distribution to the ultimate consumer. The wrapped bakery products are loaded into baskets and/or trays. The filled baskets and/or trays are stacked, and the stacks of filled baskets and/or trays are loaded into vehicles for transportation to retailers.

At the retailer the bakery products are removed from the baskets and/or trays and are displayed for sale. The empty baskets and/or trays are once again stacked, and the stacks of empty baskets and/or trays are returned to the bakery for refilling. At the bakery the empty baskets and/or trays must be unstacked to facilitate the refilling thereof.

As is well known to those skilled in the art, modern bakeries often use baskets and/or trays having different widths in their distribution operations. Notwithstanding this fact, stackers and unstackers adapted for use in conjunction with bakery product baskets and trays have heretofore been unable to accommodate baskets and/or trays of different widths.

Heretofore an attempt has been made to accommodate the stacking of multiple widths of bakery product baskets and trays by varying the positioning of the guides which direct bakery product baskets and trays into the stacking and unstacking apparatus. In actual practice it has been found that merely repositioning the guides of a bakery product basket and tray stacking and unstacking apparatus does not provide satisfactory results. This is because the plastic construction of bakery product baskets and trays dictates the support and transportation thereof along their lateral edges in order to prevent buckling and ultimate failure of filled bakery product baskets and/or trays.

The present invention comprises a width adjustment for stackers and unstackers of the type utilized in conjunction of bakery product baskets and trays which overcomes the foregoing and other problems which have long since characterized the prior art. In accordance with the broader aspects of the invention, both the guides which position bakery product baskets and trays for movement into and out of the stacking and unstacking apparatus and the basket and tray transporting apparatus of the stacker and unstacker are positioned in accordance with the widths of the baskets and trays to be stacked and unstacked. In this manner bakery product baskets and trays characterized by variety of widths can be properly received, stacked, and unstacked without risk of failure.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of a stacking and unstacking mechanism incorporating the width adjusting apparatus of the present invention;

FIG. 2 is an end view of the mechanism of FIG. 1; and

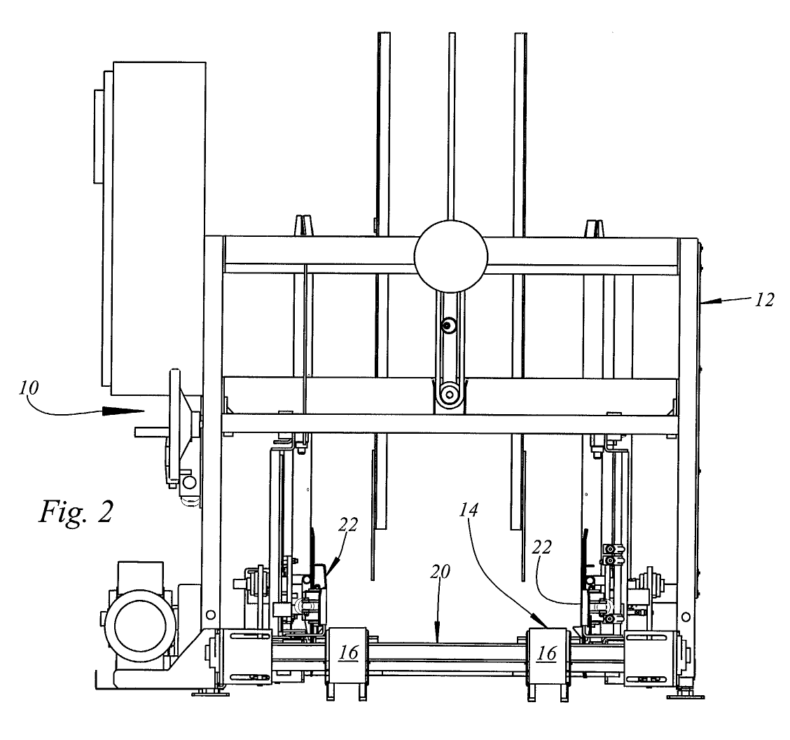

FIG. 3 is a top view of the mechanism of FIG. 1.

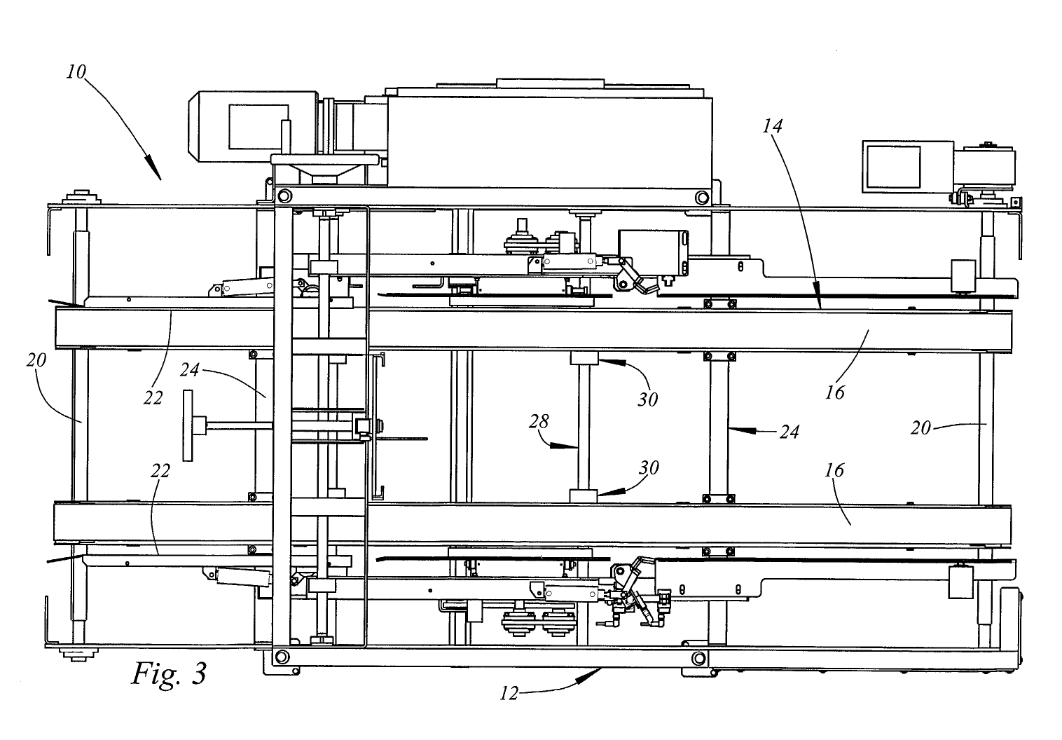

### DETAILED DESCRIPTION

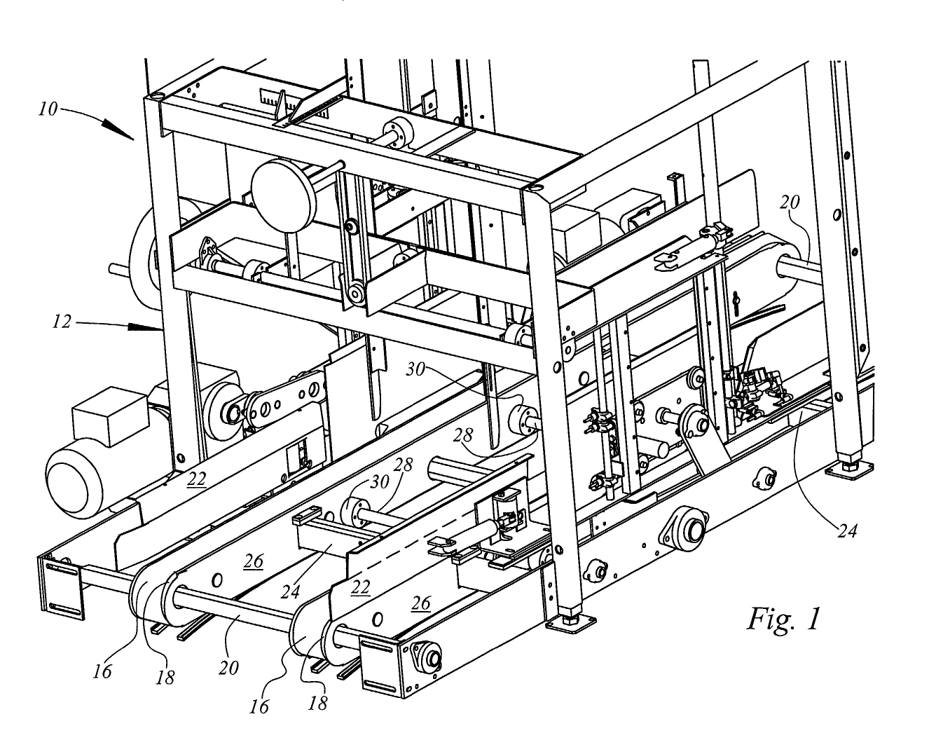

Referring now to the Drawings, and particularly to FIG. 1 thereof, there is shown a stacking and unstacking apparatus 10 of the type utilized in conjunction with bakery product baskets and trays. The apparatus 10 includes a main frame 12 which supports all of the operating instrumentalities of the apparatus 10.

The apparatus 10 includes a conveyor 14 which is utilized to move bakery product baskets and trays in and out of the apparatus 10 to facilitate the stacking and unstacking thereof. The conveyor 14 comprises spaced apart belts 16 which are trained around pulleys 18. The pulleys 18 are slidably received on non-circular shafts 20 which constrain the belts 16 to synchronous movement. Guides 22 are located adjacent the belts 16 and function to position bakery product baskets and trays relative to the conveyor 14.

A pair of spaced apart guide members 24 are supported on the main frame 12 of the stacking and unstacking apparatus 10. Subframes 26 are slidably supported on the guide members 24 for transverse movement relative to the path of travel of the belts 16 comprising the conveyor 14. The pulleys 18, the belts 16 trained therearound, and the guides 22 are supported on the subframes 26. Thus, upon transverse movement of the subframes 26 relative to the path of travel of bakery product baskets and trays into and out of the stacking and unstacking apparatus 10 under the action of the conveyor 14, the belts 16 and the guides 22 are selectively positioned to accommodate bakery product baskets and trays having varying widths.

Lead screws 28 are rotatably supported on the main frame 12 of the stacking and unstacking apparatus 10. The lead screws 28 are threadably engaged with collars 30 secured to the subframes 26. Thus, upon rotation thereof, the lead screws 28 function to selectively position the subframes 26, and therefore the belts 16 and the guides 22, to receive and transport bakery product baskets and trays having varying widths into and out of the stacking and unstacking apparatus 10. A timing chain constrains the lead screws 28 to concurrent rotation.

As will be appreciated by those skilled in the art, the width adjustment apparatus of the present invention comprises an improvement over the prior art in that not only the guides 22 but also the belts 16 are selectively positioned to accommodate bakery product baskets and trays of varying widths. In this manner the bakery product baskets and trays are supported and transported along the opposite edges thereof. In this manner the handling of filled bakery product baskets and trays is facilitated by the present invention without risk of failure due to the fact that the bakery product baskets and trays are improperly supported and transported.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. For use in conjunction with a stacking and unstacking apparatus for bakery product baskets and trays of the type having a conveyor comprising spaced apart belts for receiving and transporting bakery product baskets and trays and guide members for positioning bakery product baskets and trays relative to the conveyor, the improvement combining:
spaced apart subframes each having one of the conveyor belts and one of the guide members mounted thereon; and
means for selectively positioning the subframes transversely relative to the path of travel of bakery product baskets and trays by the conveyor belts and thereby facilitating the stacking and unstacking of bakery product baskets and trays of varying widths.

2. The improvement according to claim 1 wherein the positioning means comprises:
a lead screw;
at least two threaded members each mounted on one of the subframes and both threadedly engaged with the lead screw; and
means for selectively rotating the lead screw and thereby selectively positioning the subframes.

3. The improvement according to claim 2 further characterized by:
a pair of lead screws each extending transversely relative to the path of travel of bakery product baskets and trays by the conveyor belts;
two pairs of threaded members, the threaded members comprising each pair being threadedly engaged with one of the lead screws; and
one of the threaded members comprising each pair being secured to one of the subframes and the other threaded member comprising each pair being secured to the opposite subframe.

4. The improvement according to claim 3 further comprising means constraining the two lead screws to concurrent rotation.
